(19) United States
(12) Patent Application Publication
(10) Pub. No.: US 2002/0163654 A1
(43) Pub. Date: Nov. 7, 2002

(54) System and method of simulated increase in image resolution

(75) Inventor: Vladimir Levantovsky, North Andover, MA (US)

Correspondence Address: LAHIVE & COCKFIELD, 28 STATE STREET, BOSTON, MA, 02109, US

(73) Assignee: Oak Technology, Inc.

(21) Appl. No.: 09/815,586

(22) Filed: Mar. 23, 2001

(51) Int. Cl. B41B 1/00; B41J 1/00; G06K 1/00; G06F 15/00

(52) U.S. Cl. 358/1.2

(57) ABSTRACT

The present invention provides an approach to simulating increased printer resolutions. The present invention comprises a printing system that includes a print engine for printing at a native resolution. Also, the printing system includes a bitmap for at least a portion of an image at a higher resolution, wherein the higher resolution is higher than the native resolution. Further, the printing system has a processing unit for using a window structure for processing the bitmap to generate output for controlling the print engine to produce a printed output that simulates the higher resolution.

### TECHNICAL FIELD

The present invention relates to a printer system and more specifically to a system and method for simulation improvement of image resolution.

### BACKGROUND OF THE INVENTION

Printer engines have a native resolution, such as 300 dot per inch (dpi), 600 dpi, or 1200 dpi. The centers of the pixels for a 300 dpi resolution image are 1/300^{th}s of an inch apart in both the horizontal direction and vertical directions. The entire resolution of the marking engine may be represented by an orthogonal array of pixel locations. The size of the orthogonal array depends on the size of the area of the graphic image.

A color value can be assigned to each pixel location in the array. This color value is used in electronic displays, to control the color value displayed for the corresponding pixel. A conventional way of assigning color values is to set a value of a multibit number to encode the color value for each pixel in the array.

The resolution of images continues to increase, but printers with high native resolutions are expensive and not available to many users. As such, there is a need to be able to print such high resolution images in lower resolutions printers without sacrificing perceived resolution in the resulting printed image.

### SUMMARY OF THE INVENTION

The present invention addresses the above-described limitations of conventional printing systems and methods. The present invention provides an approach to simulating increased printer resolutions by using an algorithm to provide easier computations of values in a window structure arrangement of elements. The present invention is especially well adapted for producing output on a printer to simulate an output at twice the native resolution of the printer. Thus, for example, 1200 dpi input can be printed on a 600 dpi printer to appear as 1200 dpi output.

In one embodiment of the present invention, a printing system includes a print engine for printing at a native resolution. Also, the printing system includes a bitmap for at least a portion of an image at a higher resolution, wherein the higher resolution is higher than the native resolution. Further, the printing system has a processing unit for using a window structure for processing the bitmap to generate output for controlling the print engine to produce a printed output that simulates the higher resolution.

In accordance with another aspect of the present invention, the window structure is comprised of a 3×4 matrix of elements. Also, each element in the matrix is assigned a weighted value. The printing system further comprises a row relationship wherein the summation of each of the weighted values of each entry of the window structure are evaluated, such that a row relationship is defined as two times the sum of the first row entry and fourth new entry must be equal to the sum of the second row entry and third row entry. The row is used to control the horizontal lines created by the printing system. The printing system further defines a coefficient relationship wherein the sum of each of the weighted values of each column entry of the template are evaluated, such that a new relationship is defined as a sum of the first column entry and third column entry must be equal to the sum of the second column entry.

In one embodiment of the present invention, in a printing system with a print engine for printing in a native resolution, a method for simulating printing at a higher resolution. The method comprises providing a bitmap for at least a portion of an image having the higher resolution, wherein the higher resolution is higher than the native resolution. The method further comprises using a window structure for processing the bitmap to generate output for controlling the print engine to produce a printed output that simulates the higher resolution.

In accordance with another aspect of the present invention, the method includes an algorithm for processing an image. A window is provided that contains a 3×4 matrix of elements. Each element in the matrix is assigned a weighted value. The method further comprises a row relationship wherein the summation of each of the weighted values of each entry of the template is evaluated, such that a row relationship is defined as two times the sum of the first row entry and fourth new entry must be equal to the sum of the second row entry and third row entry. The row is used to control the horizontal lines created by the printing system. The printing system further defines a coefficient relationship wherein the sum of each of the weighted values of each column entry of the template is evaluated, such that a new relationship is defined as a sum of the first column entry and third column entry must be equal to the sum of the second column entry.

### BRIEF DESCRIPTION OF THE DRAWINGS

FIG. 1 depicts a printing system suitable for practicing an illustrative embodiment of the present invention.

FIG. 2 depicts the processing unit 11 of the printing system of FIG. 1 in more detail.

FIG. 3 illustrates the relationship between a bit and the resulting printed output in a scan line.

FIG. 4 illustrates the division of an output pixel into vertical slices in the illustrative embodiment.

FIG. 5 illustrates the window arrangement used to process a source bitmap and overlayed pixels at the native resolution of the printing system.

FIG. 6 illustrates the window with assigned weighted values.

FIG. 7 illustrates the calculation of the darkness level and center of gravity of an output pixel.

### DETAIL DESCRIPTION OF THE INVENTION

The illustrative embodiment of the present invention simulates an increase in the resolution of a printer system. Image data at a higher resolution is processed to determine what portions (or “sub-pixels”) of each lower resolution pixel (i.e., each pixel at the native resolution of the printer) are to be turned “on” or “off” per the image data. The illustrative embodiment processes the image data to generate control signals for a laser in the printer. The control signal determines when the laser is turned “on” or “off” during the scanning of a pixel. In other words, each pixel is subdivided into vertical slices and the control signals determine which of the slices are to be marked during a scan.

The illustrative embodiment of the present invention creates images by a laser beam scanning a photoconductor surface and charging spots that attract toner particles. The laser beam is continuous in time in that it can be turned “on” and “off” at any point during scan line. The laser beam may be modulated with high spatial frequency data to achieve the appearance of increased resolution in the direction of a scanline (referred to as horizontal resolution). Vertical resolution is dependent on scanline frequency and speed of the paper feed. The present invention allows for the control of vertical position of the dot key using multiple partial dots which vary in amount of charge (laser exposure) and spatial offset of the photoconductor surface. The present invention may be accomplished in a printing system which converts a bit-map image into data that has distinctly different combinations of pulse width and position to create horizontal and vertical image objects.

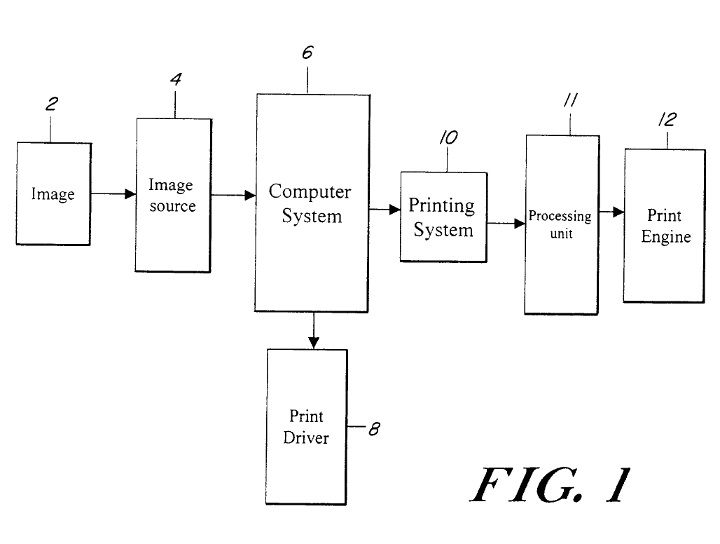

FIG. 1 depicts a printing system arrangement in accordance with the illustrative embodiment of the present invention. An image 2 is provided by an image source 4. The image 2, for example, may be produced by scanning a document. The image 2 may be a 1200 dpi image. The printer driver 8 resides in computer system 6 or in a separate embedded microprocessor system. The printer driver 8 receives the image from the image source 4 and converts the image from the image source 4 to be processed by a printing system 10 into a page description (typically encoded in a page description language). The printing system 10 processes the page description into a bitonal bitmap for 1200 dpi resolution. The bitonal bitmap is processed in the illustrative embodiment by a processing unit 11 to yield control signals. The control signals specify a pulse width (“darkness level”) and a center point (“center of gravity) for any subpixels to be printed are calculated into their corresponding transitional coordinates. These transitional coordinates are used in creating video signals that are to be passed to a print engine 12. The processing unit 11 uses the video signals to control the print engine 12.

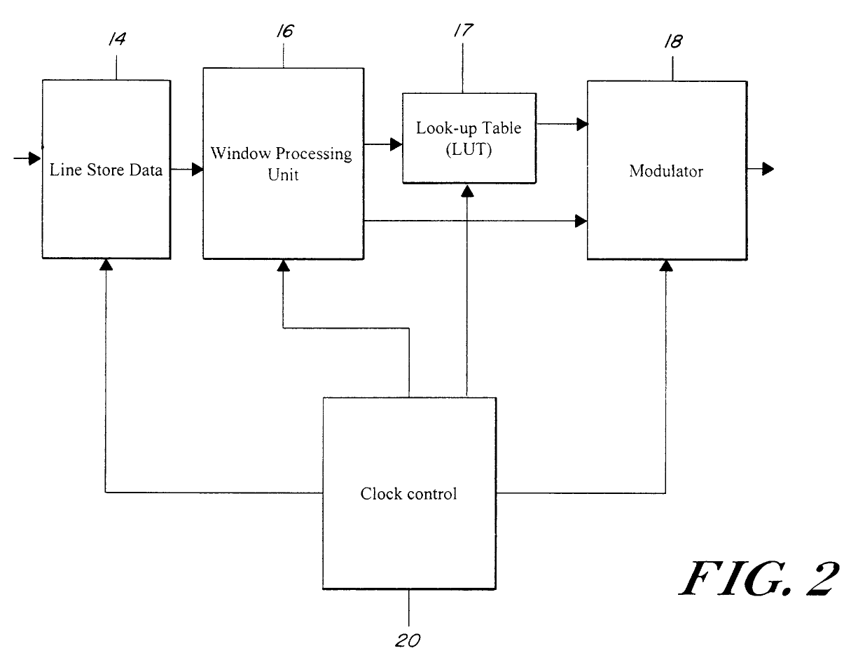

FIG. 2 illustrates components of the processing unit 11 in more detail. Incoming image information is sent from the computer system 6 to the printer driver 8, which buffers the data and generates signals to move groups of data representing an entire scan line to the print engine. The clocks and control function circuit 20 generates timing and control signals for elements, such as the line data store 14, window processing unit 16, look-up table 17, and modulator 18. The control function circuit 20 is also responsive to the horizontal and vertical synchronization signals of the printed image on the page.

The image data (from image source 4 ) is clocked from the line data store 14. Once the image data from the line data store 14 is clocked, the window processing unit 16 receives and processes image data by applying weight coefficients and calculating output values. The LUT 17 adjust the darkness level of slices corresponding to dark points created by the window processing unit 16. The output from the window processing unit 16 and LUT 17 identifies what slices in a pixel are to be set as “on” when the image is printed. In particular, the output identifies a pulse width and a center point for a portion of the pixel that is to be printed, as will be described in more detail below. A modulator circuit 18 receives the bitonal bitmap created by the window processing unit 16 and the LUT 17, and creates a transition modulated video signal that is applied to print engine 12 for control of the laser to reproduce the input image as one or more line segments and/or blanks, along the scan line of precisely controlled position and length.

The illustrative embodiment of the present invention using a windowing technique to determine what portions of a pixel (at the native resolution of the printer) are to be printed to simulate that the printer is printing at double its native resolution. Thus, a 1200 dpi bitmap for an image may be processed and printed on a 600 dpi printer such that the resulting printed output appears as if a 1200 dpi printer was used. The window contains coefficients that are to be applied to determine which sub-pixels are to be set as “on” and which are to be set as “off”.

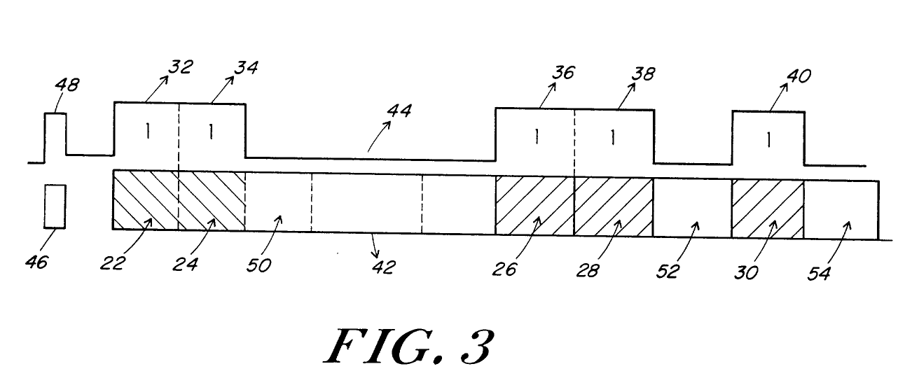

In order to appreciate operation of the illustrative embodiment, it is helpful to first review how bitmaps are used in processing image data. FIG. 3 illustrates a scan-line of a bitmap. Each pixel has an associated bit that is set as either a 1 (“on”) or a 0 (“off”). Each bit value is associated with a given color. Hence, a value “1” for a pixel indicates that the pixel has an internal foreground color (i.e., toner or ink), whereas a value of 0 indicates that the pixel has a background color (i.e., white). The use of the bitmaps simplifies the amount of data that is transferred to print an image.

The print engine processes the image one scan line at a time. A scan line roughly corresponds to a row of pixels. As the printer scans the scan line 42, it looks to the bitmap 44 to determine what color should be displayed for each pixel. A photodiode 46 is struck by the laser to generate a pulse 48 that serves as a timing event indicating the beginning of a scan line. As shown, pixels 22, 26, 28, and 30 are shown as being black pixels, and the bitmap contains a high value (i.e., “1”) for the associated bits 32, 24, 26, 38 and 40. Pixels 50, 52, and 54 are white and have low values (i.e., “0”) in the bitmap. The laser strikes the printing substrate only where “1” values are present; hence, causing toner to be attracted to the associated pixel so that a black pixel is printed.

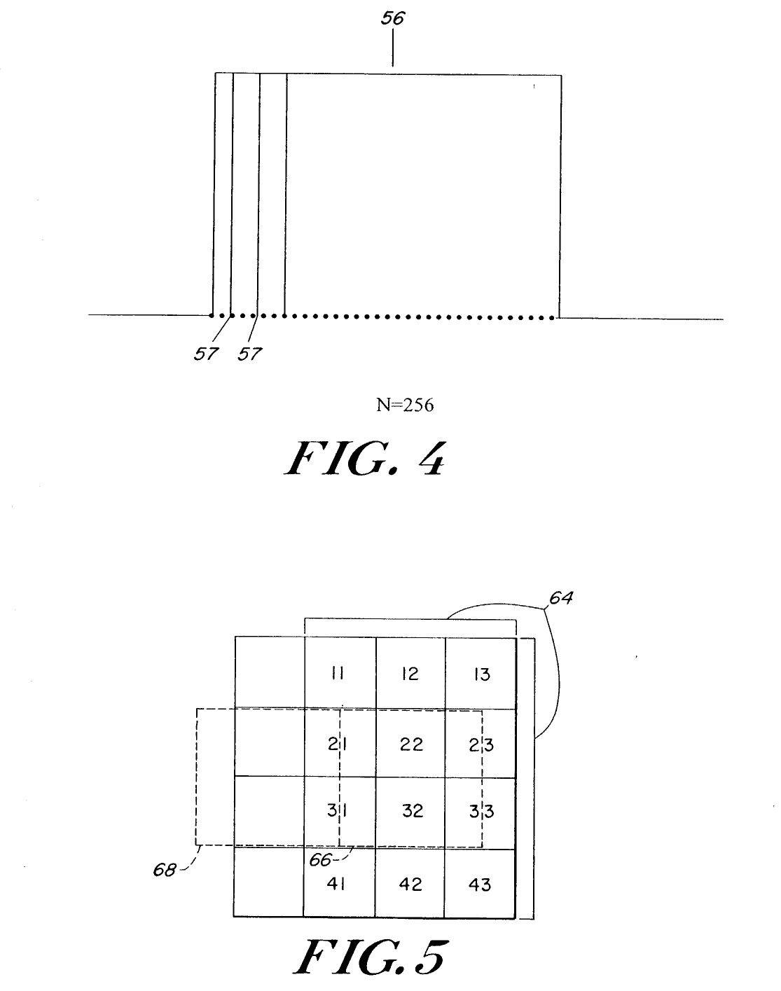

FIG. 4 illustrates the division of an output pixel into vertical slices 57 in accordance with the illustrative embodiment. The illustrative embodiment divides each output pixel 56 into 256 vertical slices or steps. A designated number of these slices may be turned “on” or “off” by sending the appropriate control signals to control the laser. This allows selected portion of a pixel to be turned “on” or “off”. The control signals specify a pulse width (with a maximum value of 256) that specifies how many of the slices are to be continuously set “on” (i.e., the width in slices) and also specifies where the pulse is to be centered. Thus, a width of 128 at center point 128 is a pulse of 128 consecutive slices centered at the 128^{th} slice in the pixel.

FIG. 5 illustrates the window arrangement used to process a source image bitmap. For purposes of illustration, the source bitmap received by the window processing routine 16 is presumed to be 1200 dpi and the native resolution of the print engine is presumed to be 600 dpi. The present invention uses a processing window 64 which contains a 3×4 matrix of elements (designated as 11, 12, . . . , 43 in FIG. 5). The window 64 has programmable weight coefficients for each element. The programmable weight coefficients are based on the arrangement of the slices in the pixels of the printer. The window 64 is slid to process each pixel in a scan line. Thus, the window 64 is first positioned to center around pixel 68 and then slid to center around pixel 66 (as shown in FIG. 5). To generate output for the pixels in the scan line that contains pixels 66 and 68, the window is slid over by two elements for each consecutive pixel. For a new scan line the window is slid down by two elements. Thus, for the pixel immediately below pixel 66 in the next scan line, the window is shifted down so that the top row contains elements 31, 32, and 33.

FIG. 5 also shows the mapping of a 600 dpi pixel 66 on to the 1200 dpi elements. An adjacent 600 dpi pixel 68 is also shown in FIG. 5. Since the 1200 dpi bitmap is twice the resolution of 600 dpi, the 600 dpi pixels each roughly correspond to 2×2 1200 dpi elements.

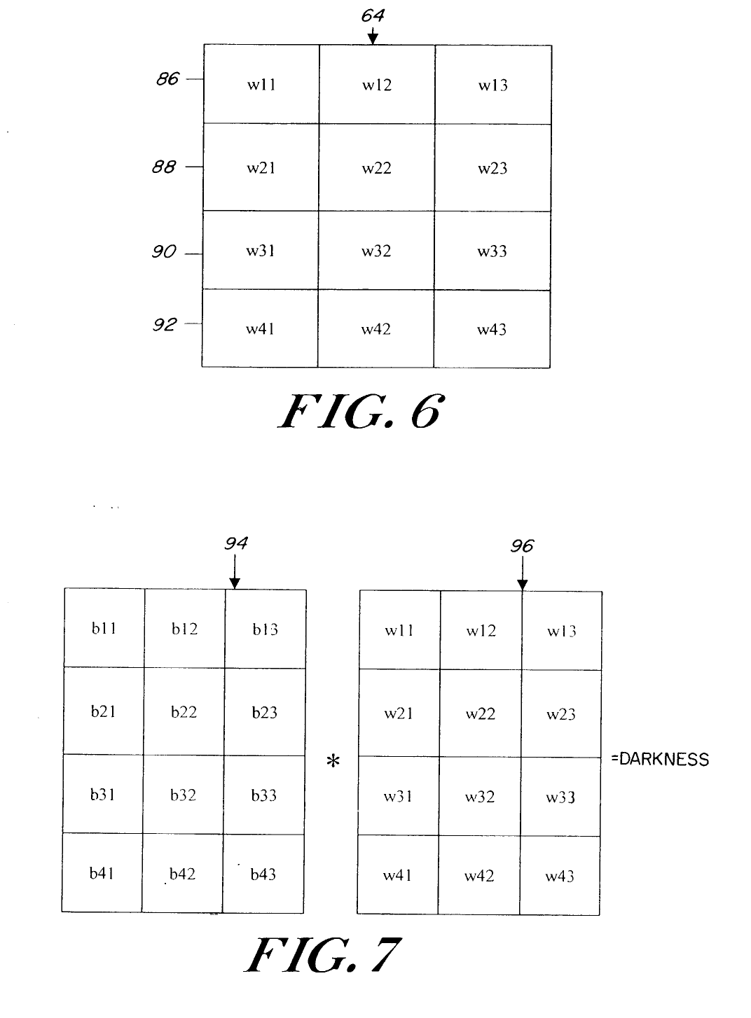

FIG. 6 depicts window 64 with assigned weighted values. The window is broken into various elements or matrix indices. Each index in the window corresponds to a pixel bit value. The window processing unit 16 and look-up table (LUT) 17 are used to process data associated with window 64. The actual weighted values of each element in the window 64 can be assigned or designated by the user of the system. The restrictions on the assignment of the weighted values are required for the efficient processing of an image.

For example, weighted value w11 86, weighted value w12 88, weighted value w13 90, and weighted value 92 are the assigned weighted values of each of first row elements in the window. The algorithm calculates the summation of each of the weighted values of the elements of each row in the window.

$$L1 = {\sum }_{1}^{3} w1i$$

$$L2 = {\sum }_{1}^{3} w2i$$

$$L3 = {\sum }_{1}^{3} w3i$$

$$L4 = {\sum }_{1}^{3} w4i$$

Wherein the sum of all the weighted values is approximately 256.

$${\sum }_{ij} ( wij ) ≅ 256$$

The algorithm requires that a row relationship be defined such that two times the sum of the first row entry and fourth row entry must be approximate to the sum of the second row entry and third row entry, i.e.:

2*(L1+L4)≅L2+L3 (row relationship); wherein

L1≅L4 and L2≅L3 (row symmetrical relationship)

The row relationship and row symmetrical relationship is used to control and establish the horizontal lines created by the printing system to establish the row elements of the window 64.

The algorithm also establishes a coefficient relationship. The coefficient relationship is defined by the summation of each of the weighted values of each column entry of the template. Also, the coefficient relationship requires that the sum of the first column entry and third column entry must be approximate to the sum of the second column entry, i.e.:

$$C1 = {\sum }_{1}^{4} w i1$$

$$C2 = {\sum }_{1}^{4} w i2$$

$$C3 = {\sum }_{1}^{4} w i3 \\ ( coefficient relationship )$$

C2≅C1+C3 (coefficient relationship)

C1≅C3 (coefficient symmetrical relationship)

The adherence to the coefficient relationship and coefficient symmetrical relationship allows for the controlling of vertical lines produced by the printing system.

The algorithm establishes a diagonal relationship wherein the summation of each of the weighted values of each diagonal entry of the window:

DL11=w12+w23 DL12=w11+w22+w33 (first left diagonal elements)

DR11=w21+w12 DR12=w31+w22+w13 (first right diagonal elements)

DL21=w42+w33 DL22=w41+w32+w23 (second left diagonal elements)

DR21=w42+w31 DR22=w43+w32+w21 (second right diagonal elements)

wherein the DL11 is the first upper left diagonal element and DL12 is the second upper left diagonal element. Diagonal elements DR11 and DR12 are the first upper right diagonal element and second upper right diagonal element respectively. Diagonal elements DL21 and DL22 are the first lower left diagonal element and second lower left diagonal element respectively. Diagonal element DR21 and DR22 are the first lower right diagonal element and second lower right diagonal element respectively. These diagonal elements further follow the row and coefficient relationships defined above. Thus, the diagonal relationship is related to the row and coefficient relationships.

The diagonal relationship is defined wherein the diagonal element DL11 and diagonal DR11 element must be approximately equal each other and the diagonal element DL12 and diagonal DR12 must be approximately equal to each other. Also, the diagonal element DL21 and diagonal DR21 element must be approximately equal to each other and the diagonal element DL22 and diagonal DR22 must be approximately equal to each other

DL11≅DR11 DL12≅DR12 (diagonal relationship)

DL21≅DR21 DL22≅DR22

The diagonal lines form symmetrical pairs of left diagonal and right diagonal elements. Any arbitrary pixel combination in the template should not generate weighted value equal to row, coefficients, and diagonal relationships.

The strict adherence of the weighted values in window 64 allows for a computational intensive approach to calculating darkness values of an output pixel. The assignment of the 3×4 matrix allows more freedom to control more precisely the output presented to modulator 18. However, the modulator 18 requires more information for the processing of an image as described below.

FIG. 7 illustrates the technique used to calculate the darkness level and center of gravity of an output pixel. Modulator 18 requires information regarding the center of gravity of the output pixel and a darkness value. The darkness refers to the number of slices to be set as “on” (i.e. it refers to the pulse width) and center of gravity refers to where the pulse will be centered (as describe above). The present invention utilizes convoluting window data 94 with window weights 96 in order to calculate the darkness of the output pixel. Since source image has binary representations, calculation of the darkness value is the sum of those window coefficients, which are mapped with black source pixels.

$$Darkness = {\sum }_{ij} ( Bij * wij )$$

The center of gravity of the output pixel is determined as a weighted balance between sums of left, center, and right columns.

$$Q1 = {\sum }_{i = 1}^{4} ( Bi1 * w i1 ) , \\ Q2 = {\sum }_{i = 1}^{4} ( Bi2 * w i2 ) , \\ Q3 = {\sum }_{i = 1}^{4} ( Bi3 * w i3 ) , \\ Center of Gravity ≅ k1 * Q1 + k2 * Q2 + k3 * Q3$$

wherein coefficients k1, k2, and k3 are based on the properties of the laser printer used. Thus, calculating for the center of gravity requires deriving these coefficient values. Which entails that the coefficient values may be different among printers.

Calculated darkness and center of gravity values drive modulator 18 to generate video signal to print engine 12. Look-up table 17 is used to adjust the darkness of the output pixel. Thus, the present invention allows for the reproduction of 1200 dpi source bitmap on a 600 dpi engine using pulse modulation techniques along the laser scanline and vertical interaction of charge spots in between scanlines.

Numerous modifications and alternative embodiments of the invention will be apparent to those skilled in the art in view of the foregoing description. Accordingly, this description illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law. The size of the window, weighted values, and resolution can vary without changing the scope of the invention. The present invention may be practiced with a number of types of devices including copiers, laser printers, and facsimile machines. Moreover, the present invention is not limited to cases where the input bitmap is 1200 dpi and the native resolution is 600 dpi. For example, the input resolution may be 600 dpi, or 2400 dpi with the native resolution 300 dpi and 1200 dpi, respectively.

Having described the invention, what is claimed as new and protected by Letters Patent is:

What is claimed is:

1. A printing system, comprising:
a print engine for printing at a native resolution;
a bitmap for at least a portion of an image at a higher resolution, wherein said higher resolution is higher than the native resolution; and
a processing unit for using a window structure for processing the bitmap to generate output for controlling the print engine to produce a printed output that simulates the higher resolution.

2. The printing system as recited in claim 1 wherein the higher resolution is at least twice the native resolution of the printing system.

3. The printing system as recited in claim 1 wherein the printing system is a laser printer.

4. The printing system as recited in claim 3 wherein the printing system modulates a laser beam to print the bitmap at the higher resolution.

5. The printing system as recited in claim 1 wherein the window structure is comprised of a plurality of elements assigned in a matrix.

6. The printing system as recited in claim 1 wherein the window structure is a 3×4 matrix arrangement.

7. The printing system as recited in claim 5 wherein each of the elements in the matrix is assigned a weighted value.

8. The printing system as recited in claim 7 wherein the matrix exhibits a row relationship such that a sum of a summation of weighted values in a second row of the matrix and a summation of weighted values in a third row of the matrix are approximately equal to two times a sum of a summation of weighted values in a first row of the matrix with a summation of weighted values in a fourth row of the matrix.

9. The printing system as recited in claim 8 wherein the matrix exhibits a row symmetrical relationship such that the summation of the weighted values of the second row is approximately equal to the summation of the weighted values of the third row of the matrix and the summation of the weighted values of the first row is approximately equal to the summation of the weighted values of the fourth row of the matrix.

10. The printing system as recited in claim 8 wherein the matrix exhibits a coefficient symmetrical relationship such that a summation of weighted values in a second column if the matrix is approximately equal to a sum of a summation of weighted values in a first column of the matrix with a summation of weighted values in a third column of the matrix.

11. The printing system as recited in claim 10 wherein the matrix exhibits a coefficient relationship such that the summation of weighted values of the first column of the matrix is approximately equal to the summation of weighted values of the third column.

12. The printing system as recited in claim 10 wherein the matrix exhibits a diagonal relationship where diagonal elements in the matrix are constrained to their respective row and coefficient relationships.

13. The printing system as recited in claim 12 wherein the matrix exhibits a relationship wherein any arrangement in the window should not generate weighted values equal to the row, coefficients, and diagonal relationships.

14. In a printing system with a print engine for printing in a native resolution, a method for simulating printing at a higher resolution, the method comprising:
providing a bitmap for at least a portion of an image having the higher resolution, wherein the higher resolution is higher than the native resolution; and
using a window structure for processing the bitmap to generate output for controlling the print engine to produce a printed output that simulates the higher resolution.

15. The method as recited in claim 14 wherein said higher resolution is at least twice the native resolution.

16. The method as recited in claim 14 wherein the printing system is a laser printer.

17. The method as recited in claim 16 wherein the printing system modulates a laser beam to print an image.

18. The method as recited in claim 14 wherein the window structure is comprised of a plurality of elements assigned in a matrix.

19. The method as recited in claim 14 wherein the window structure is a 3×4 matrix arrangement.

20. The method as recited in claim 18 wherein each of the elements in the matrix is assigned weighted values.

21. The method as recited in claim 20 wherein the matrix exhibits a row relationship such that a sum of a summation of weighted values in a first row of the matrix and a summation of weighted values in a fourth row of the matrix are approximately equal to two times a sum of a summation of weighted values in a second row of the matrix with a summation of weighted values in a third row of the matrix.

22. The method as recited in claim 21 wherein the matrix exhibits a row symmetrical relationship such that the summation of the weighted values of the second row is approximately equal to the summation of the weighted values of the third row of the matrix and the summation of the weighted values of the first row is approximately equal to the summation of the weighted values of the fourth row of the matrix.

23. The method as recited in claim 21 wherein the matrix exhibits a coefficient relationship such that a summation of weighted values in a second column if the matrix is approximately equal to a sum of a summation of weighted values in a first column of the matrix with a summation of weighted values in a third column of the matrix.

24. The method as recited in claim 23 wherein the matrix exhibits a coefficient symmetrical relationship such that the summation of weighted values of the first column of the matrix is approximately equal to the summation of weighted values of the third column.

25. The method as recited in claim 23 the matrix exhibits a diagonal relationship where diagonal elements in the matrix are constrained to their respective row and coefficient relationships.

26. The method as recited in claim 25 wherein the matrix exhibits a relationship wherein any arrangement in the window should not generate weighted values equal to the row, coefficients, and diagonal relationships.
